(19) United States
(12) Patent Application Publication
(10) Pub. No.: US 2010/0277501 A1
(43) Pub. Date: Nov. 4, 2010

(54) IMAGE DISPLAY METHOD AND IMAGE DISPLAY DEVICE

(76) Inventor: Masahiko MIZUKI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/764,604

(22) Filed: Apr. 21, 2010

(30) Foreign Application Priority Data
Apr. 30, 2009 (JP) P2009-111421
Jul. 2, 2009 (JP) P2009-157814

(51) Int. Cl. G09G 5/02; G09G 5/00

(52) U.S. Cl. 345/592; 345/634; 345/589

(57) ABSTRACT

An image display method and an image display device, which may reduce burn-in caused by a still image displayed on part of a screen, respectively, are provided. In the image display method, a non-self-luminous display device is driven, so that a content image is displayed on a screen, and a functional image is displayed on part of the screen, and besides, the functional image is temporally expanded or reduced with a predetermined, fixed position as a reference.

### BACKGROUND OF THE INVENTION

1. Field of the Invention

The present invention relates to an image display method and an image display device, in each of which a non-self-luminous device such as liquid crystal device is driven for image display.

2. Description of Related Art

In a liquid crystal display device, arrangement of liquid crystal molecules is changed in a liquid crystal layer enclosed between substrates of glass or the like, so that light from a light source is transmitted or modulated for image display. In the liquid crystal display device, when a still image is displayed on a screen for a long time, burn-in occurs. The burn-in is a phenomenon that a DC voltage component formed within the liquid crystal makes movable ions of an ionic impurity or the like to be localized within a liquid crystal layer and in a boundary between the liquid crystal layer and an alignment film, so that voltage applied to the liquid crystal becomes asymmetric, causing change in effective luminance, and consequently luminance is kept to be changed in correspondence to a display pattern of a still image.

The still image may be displayed on the whole screen, or displayed small in a corner of the screen. The still image is displayed on the whole screen, for example, in the case of displaying a test image (for example, color bars) transmitted from a broadcasting station, or photograph data inputted from an external device (not illustrated) by a user itself. In contrast, the still image is displayed only on part of the screen, for example, in the case of displaying information used for explaining features of goods in the store (so-called, POP (Point of Purchase Advertizing)), time, display channels and the like.

The burn-in is hard to be completely solved through improving materials of a liquid crystal element or improving a manufacturing process. Thus, for example, Japanese Unexamined Patent Application Publication No. 2006-235241 describes displaying a still image by a devised method in the case that the image is displayed on the whole screen. Specifically, an image to be displayed is beforehand expanded or reduced with respect to a screen, then the image is moved tracing a figure of eight or the like, and thus burn-in is reduced.

### SUMMARY OF THE INVENTION

However, when a display image has large display area at the same signal level, the method described in the above-mentioned patent application may not reduce burn-in in a portion away from a boundary of the region although the method may reduce bum-in in the boundary. Such a difficulty occurs even in the case that the method is used in a case where a still image is displayed on only part of a screen.

It is desirable to provide an image display method and an image display device, which may reduce burn-in caused by a still image displayed on part of a screen, respectively.

According to an image display method of an embodiment of the invention, a non-self-luminous display device is driven, so that a content image is displayed on a screen, and a functional image is displayed on part of the screen, and besides, the functional image is temporally expanded or reduced with a predetermined, fixed position as a reference.

According to an embodiment of the invention, there is provided an image display device including: a non-self-luminous display device having a screen; an illumination section illuminating the display device; and a drive section driving the display device so that a content image is displayed on the screen, and a functional image is displayed on part of the screen, and besides, the functional image is temporally expanded or reduced with a predetermined, fixed position as a reference.

According to each of the image display method and the image display device of the embodiment of the invention, the non-self-luminous display device is driven, so that the content image is displayed on the whole screen, and the functional image is displayed on part of the screen, and besides, the functional image is temporally expanded or reduced with a predetermined, fixed position as a reference. Thus, even if the functional image has large display area at the same signal level, it may be prevented that a particular pixel is continuously applied with an image signal at a constant level.

In particular, it is preferable that the functional image is expanded or reduced in such a manner that when the total area of a screen is assumed to be 1, area of the functional image is 0.01 or more at the maximum, and 0 at the minimum. In such a case, it may be securely prevented that a particular pixel of the functional image is continuously applied with an image signal at a constant level.

According to each of the image display method and the image display device of the embodiment of the invention, it may be prevented that a particular pixel of the functional image is continuously applied with an image signal at a constant level, which may reduce burn-in caused by a still image displayed on part of a screen. In particular, the functional image is expanded or reduced in such a manner that when the total area of a screen is assumed to be 1, area of the functional image is 0.01 or more at the maximum, and 0 at the minimum, which may more reduce burn-in caused by a still image displayed on part of a screen.

Other and further objects, features and advantages of the invention will appear more fully from the following description.

### BRIEF DESCRIPTION OF THE DRAWINGS

FIG. 1 is a schematic block diagram of a liquid crystal display device according to an embodiment of the invention.

FIG. 2 is a block diagram of a pixel array section of FIG. 1.

FIGS. 3A and 3B are schematic diagrams illustrating an example of a layout of a content image and a functional image on a screen.

FIGS. 4A and 4B are schematic diagrams illustrating an example of a reference point (fixed point) for expansion or reduction of the functional image.

FIGS. 5 5A and 5B are schematic diagrams illustrating another example of a reference point (fixed point) for expansion or reduction of the functional image.

FIGS. 6A to 6D are diagrams illustrating an example of variation with time of luminance of the functional image.

### DETAILED DESCRIPTION OF THE PREFERRED EMBODIMENTS

Hereinafter, a preferred embodiment of the invention will be described in detail with reference to drawings. Description is made in the following sequence.

1. Schematic configuration

2. Advantages

Schematic Configuration

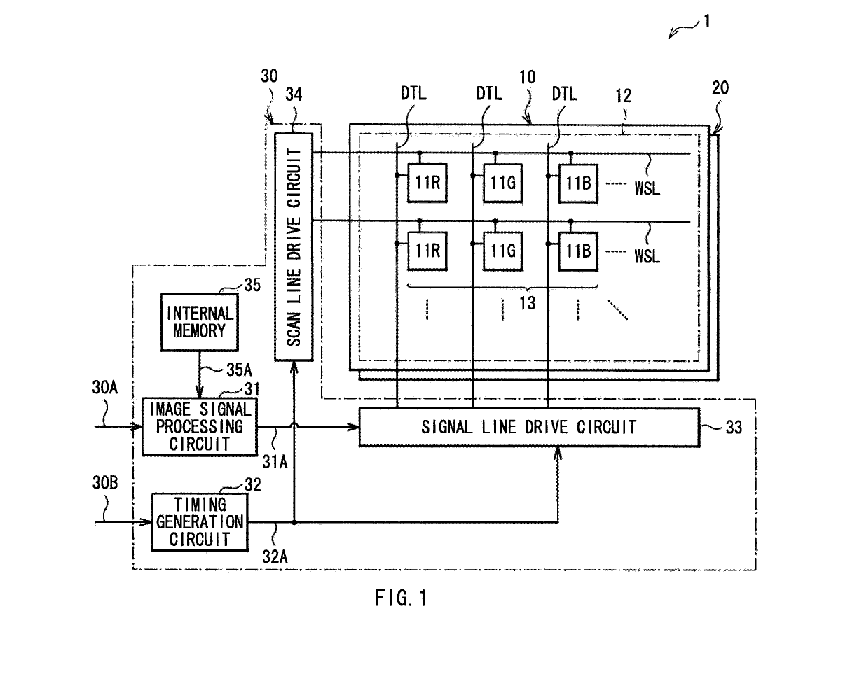

FIG. 1 illustrates a schematic configuration of a liquid crystal display device 1 according to an embodiment of the invention. The liquid crystal display device 1 includes a liquid crystal display panel 10, a backlight 20 (illumination section) disposed in the back of the liquid crystal display panel 10, and a drive circuit 30 (drive section) driving the liquid crystal display panel 10. The liquid crystal display panel 10 has a pixel array section 12 having, for example, a plurality of sub-pixels 11R, 11G and 11B arranged in a matrix pattern. In the embodiment, for example, sub-pixels 11R, 11G and 11B adjacent to one another configure one pixel 13, and the pixel array section 12 as a whole corresponds to a screen 40 (see FIG. 3A described later). Hereinafter, a sub-pixel 11 is appropriately used as a generic name of the sub-pixels 11R, 11G and 11B. The drive circuit 30 has, for example, an image signal processing circuit 31, a timing generation circuit 32, a signal line drive circuit 33, a scan line drive circuit 34, and an internal memory 35.

Pixel Array Section 12

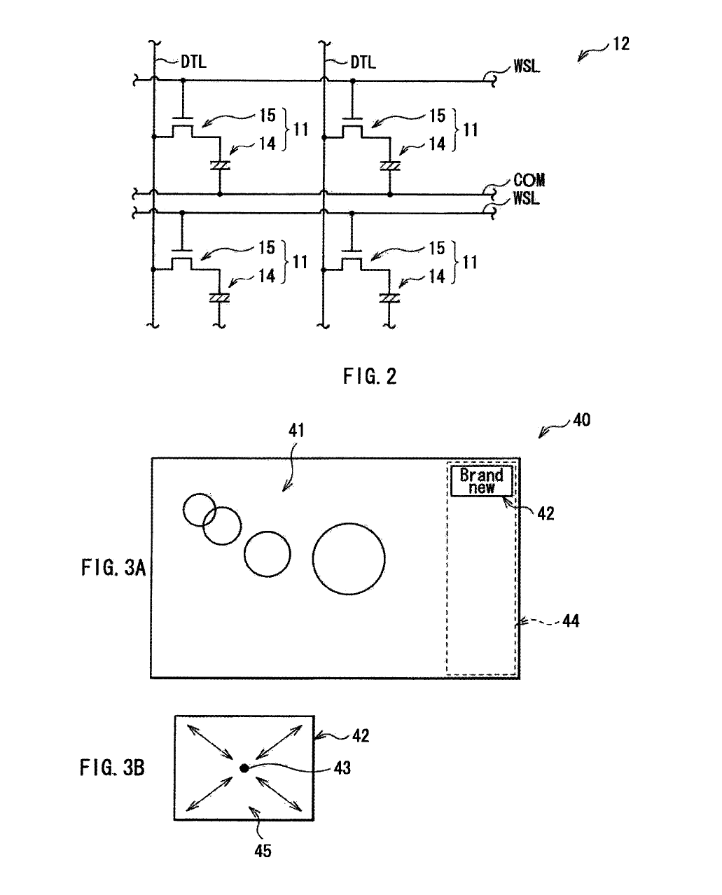

FIG. 2 illustrates an example of a circuit configuration within the pixel array section 12. The pixel array section 12 has, for example, a plurality of scan lines WSL arranged in a row pattern, and a plurality of signal lines DTL arranged in a column pattern as illustrated in FIGS. 1 and 2. A plurality of sub-pixels 11 are arranged in a matrix pattern in correspondence to intersections of the scan lines WSL and the signal lines DTL, respectively. In the pixel array section 12, for example, common potential lines COM are further formed in correspondence to all the sub-pixels 11.

For example, each sub-pixel 11 has a liquid crystal element 14 (non-self-luminous display element) and a transistor 15. Each liquid crystal element 14 has, for example, a common electrode, an insulating film, a pixel electrode, an alignment film, a liquid crystal layer, an alignment film, and a transparent substrate on a drive substrate in order from a drive substrate side. The drive substrate includes, for example, a glass substrate having the transistors 15 formed thereon. The common electrode is, for example, formed extending the whole pixel array section 12, and commonly used by all the liquid crystal elements 14 included in the sub-pixels 11. For example, the common electrode corresponds to the common connection line COM. The insulating film isolates between the common electrode and the pixel electrode to form a certain gap in a height direction between the common and pixel electrodes. The liquid crystal layer includes, for example, liquid crystal of a VA (Vertical Alignment) mode, and has a function of transmitting or blocking light emitted from the backlight 20 depending on applied voltage. The pixel electrode acts as an electrode for each of the sub-pixels 11, and for example, disposed in a region opposed to the common electrode. Thus, when voltage is applied between the pixel electrode and the common electrode, a vertical electric field is generated in the liquid crystal layer. The transistor 15 is, for example, field-effect TFT (Thin Film Transistor), and includes a gate controlling a channel, and a source and a drain provided on both ends of the channel.

One end of the liquid crystal element 14 is connected to the source or drain of the transistor 15, and the other end thereof is connected to the common connection line COM. The gate of the transistor 15 is connected to the scan line WSL, and one of the source and drain of the transistor 15, which is unconnected to the liquid crystal element 14, is connected to the signal line DTL. In a plurality of sub-pixels 11 on one horizontal line, for example, gates of transistors 15 are connected to a common scan line WSL. In the plurality of sub-pixels 11 on one horizontal line, for example, the gates of transistors 15 may be alternately connected to two scan lines WSL provided on both sides of the respective sub-pixels 11R, 11G and 11B instead of being connected to the common scan line WSL.

Backlight 20

The backlight 20 illuminates the liquid crystal display panel 10 from the back, and has, for example, a light guide plate, a light source disposed on a side face of the light guide plate, and an optical element disposed on a top (light emitting surface) of the light guide plate. The light guide plate guides light from the light source to the top of the light guide plate, and, for example, has a predetermined patterned shape on at least one of the top and a bottom, and has a function of scattering and equalizing incident light from the side face. The light source is a linear light source, and, for example, includes a hot cathode fluorescent lamp (HCFL), a cold cathode fluorescent lamp (CCFL), or a plurality of LEDs arranged in a line. The optical element is a laminated element including a diffuser panel, a diffuser sheet, a lens film, and a polarization isolation sheet. The backlight 20 may include a directly-below light source including linear light sources or dot-like light sources arranged on a back of the liquid crystal panel 10, and an optical element disposed between the back of the liquid crystal panel 10 and the light source.

Drive Circuit 30

Next, circuits in the drive circuit 30 provided in the periphery of the pixel array section 12 are described with reference to FIG. 1.

The image signal processing circuit 31 corrects an externally inputted, digital content image signal 30A, and synthesizes the corrected content image signal 30A and a digital, functional image signal 35A read from the internal memory 35. Furthermore, the image signal processing circuit 31 converts the synthesized image signal into an analog image signal 31A.

The content image signal 30A includes, for example, a moving-image signal transmitted from a broadcasting station, or a moving-image signal inputted from an external device (not illustrated) by a user itself. The moving-image signal conceptually includes a signal of display images being changed with time, for example, a signal of display images being different at intervals of one frame period, or a signal of display images being different at intervals of several frame-periods. The drive circuit 30 uses the content image signal 30A to display a content image 41 on the whole or part of the screen 40, for example, as illustrated in FIG. 3A. On the other hand, the functional image signal 35A includes, for example, information used for explaining features of goods in the store (so-called, POP) or time information, which conceptually includes a signal of display images being different at intervals of several frame-periods, or a signal of display images being not changed with time (still image signal). The drive circuit 30 uses the functional image signal 35A to display a functional image 42 on part of the screen 40 (for example, on a right or left side), for example, as illustrated in FIG. 3A. A plurality of circles in FIG. 3A schematically illustrate an aspect that a circle is temporally changed on the screen 40, representing that the content image 41 is configured of, for example, a moving image. In FIG. 3A, “Brand new” illustrates letters displayed as the functional image 42.

The image signal processing circuit 31 synthesizes the content image signal 30A and the functional image signal 35A so that the functional image 42 may be displayed on part of the screen 40 while displaying the content image 41 on the whole screen 40, for example, as illustrated in FIG. 3B. Furthermore, the image signal processing circuit 31 synthesizes the content image signal 30A and the functional image signal 35A such that the functional image 42 is temporally expanded or reduced with a predetermined, fixed position 43 (black point in the figure) as a reference. The image signal processing circuit 31 performs the synthesis processing in such a manner that the functional image 42 is expanded or reduced such that when the total area of the screen 40 is assumed to be 1, area of the functional image 42 is, for example, 0.01 or more at the maximum, and 0 (not displayed) at the minimum.

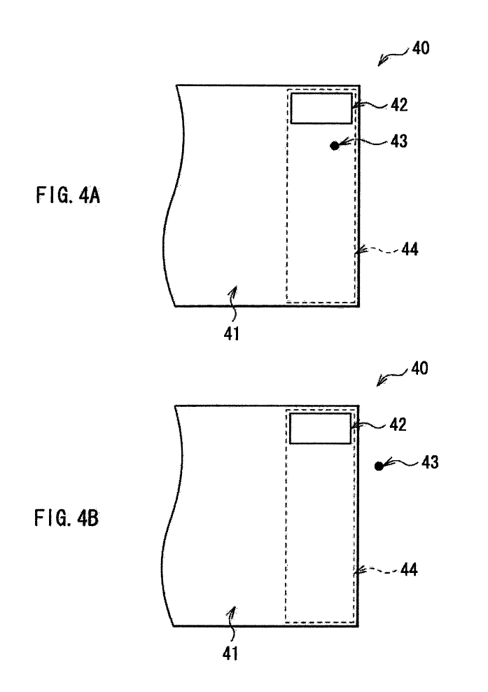

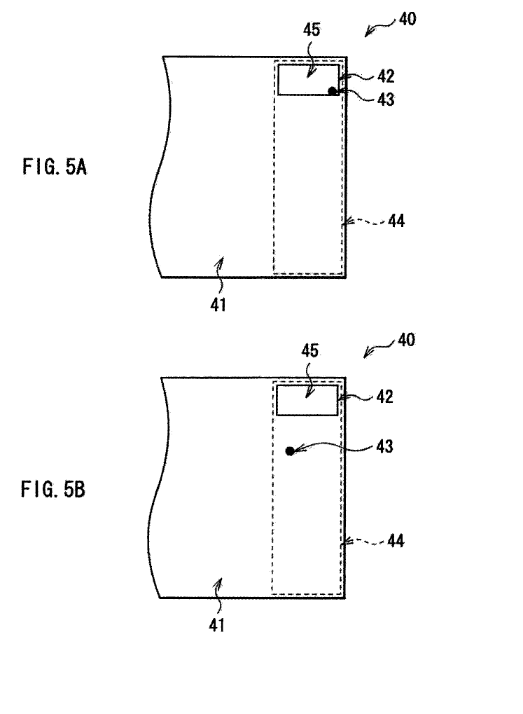

The image signal processing circuit 31 may synthesize the content image signal 30A and the functional image signal 35A such that the functional image 42 is temporally expanded or reduced with the predetermined, fixed position 43 being set at a barycenter position of the functional image 42, for example, as illustrated in FIG. 3B. However, the image signal processing circuit 31 may perform such synthesis so that the functional image 42 is expanded or reduced with the fixed position 43 being set at another position. For example, the image signal processing circuit 31 may set the fixed position 43 within a special region 44 in which the functional image 42 may be displayed as illustrated in FIG. 4A, or may set the fixed position 43 outside the special region 44 as illustrated in FIG. 4B. FIG. 4B illustrates a case where the fixed position 43 is set outside the special region 44 in which the functional image 42 may be displayed, and besides, outside the screen 40. In addition, for example, the image signal processing circuit 31 may set the fixed position 43 within a display region 45 in which the functional image 42 is currently displayed as illustrated in FIG. 5A, or may set the fixed position 43 outside the display region 45 as illustrated in FIG. 5B.

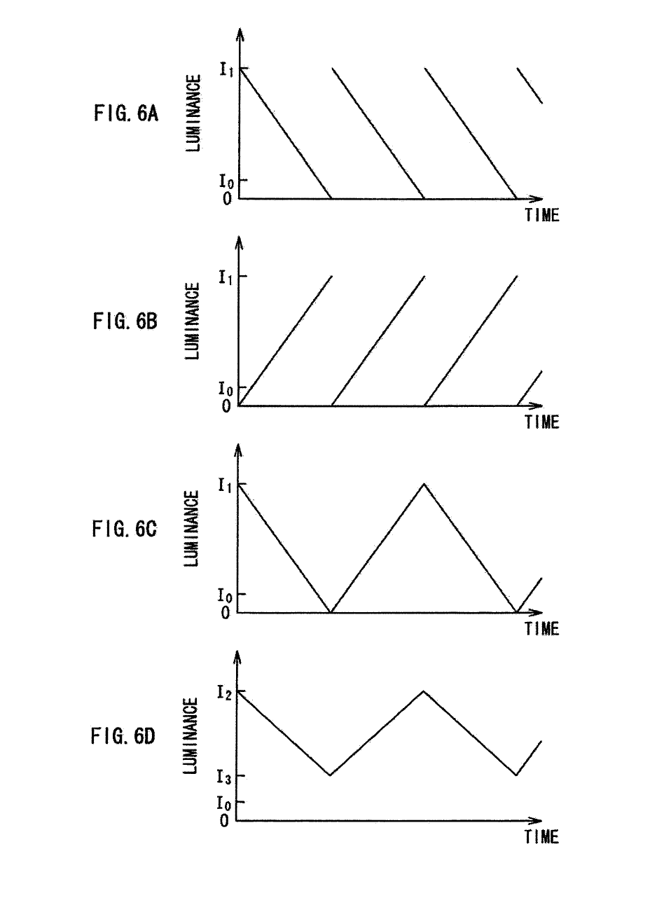

Moreover, for example, the image signal processing circuit 31 may expand or reduce the functional image 42 in such a manner that the functional image 42 is faded out. For example, as illustrated in FIG. 6A, the image signal processing circuit 31 may temporally (continuously or intermittently) change a luminance level of the functional image 42 from a luminance level I₁ (≧I₀, I₁ is a lower limit of a visible luminance level), at which the functional image 42 is visible, to a luminance level (for example, zero) at which the functional image 42 is invisible. Conversely, for example, the image signal processing circuit 31 may expand or reduce the functional image 42 in such a manner that the functional image 42 is faded in. For example, as illustrated in FIG. 6B, the image signal processing circuit 31 may temporally (continuously or intermittently) change a luminance level of the functional image 42 from the luminance level (for example, zero), at which the functional image 42 is invisible, to the luminance level I₁ at which the functional image 42 is visible. In addition, for example, the image signal processing circuit 31 may expand or reduce the functional image 42 in such a manner that the functional image 42 is temporally alternately faded out and faded in. For example, as illustrated in FIG. 6C, the image signal processing circuit 31 may temporally change a luminance level of the functional image 42 in a manner of alternately repeating temporal change from the luminance level I₁, at which the functional image 42 is visible, to the luminance level (for example, zero) at which the functional image 42 is invisible, and temporal change from the luminance level (for example, zero), at which the functional image 42 is invisible, to the luminance level I₁ at which the functional image 42 is visible. In addition, for example, the image signal processing circuit 31 may expand or reduce the functional image 42 in such a manner that a luminance level of the functional image 42 is increased and decreased within a luminance level range (I₁ or more) in which the functional image 42 is visible. For example, as illustrated in FIG. 6D, the image signal processing circuit 31 may temporally change a luminance level of the functional image 42 in a manner of alternately repeating temporal change from a high luminance level I₂ to a low luminance level I₃ and temporal change from the low luminance level I₃ to the high luminance level I₂.

Moreover, the image signal processing circuit 31 may synthesize the content image signal 30A and the functional image signal 35A such that the functional image 42 is displayed, for example, in a manner that an image portion of the content image 41 in the back of the functional image 42 is perfectly blocked (invisible). In addition, the image signal processing circuit 31 may synthesize the content image signal 30A and the functional image signal 35A such that the functional image 42 is displayed, for example, in a manner that at least part of the image portion of the content image 41 in the back of the functional image 42 is transparent (in a so-called blended-state). Furthermore, the image signal processing circuit 31 may synthesize the content image signal 30A and the functional image signal 35A such that a blending ratio of the image portion in the back of the functional image 42 and the functional image 42 is temporally (continuously or intermittently) changed.

The timing generation circuit 32 controls the signal line drive circuit 33 and the scan line drive circuit 34 to operate in conjunction with each other. For example, the timing generation circuit 32 outputs a control signal 32A to each of the drive circuits in response to (in synchronization with) an externally inputted, synchronizing signal 30B.

The signal line drive circuit 33 applies an analog image signal (signal potential corresponding to the content image signal 30A) inputted from the image signal processing circuit 32 to each signal line DTL to write the analog image signal to a sub-pixel 11 being a selection object. For example, the signal line drive circuit 33 may output a signal voltage V_{sig} corresponding to the content image signal 30A.

The scan line drive circuit 34 sequentially applies a selection pulse to a plurality of scan lines in response to (in synchronization with) an inputted control signal 32A to sequentially select a plurality of sub-pixels 11 in a unit of the scan line WSL. For example, the scan line drive circuit 34 may output a voltage Vₒₙ applied in the case of turning on the transistor 15, and a voltage V_{off} applied in the case of turning off the transistor 15. The voltage Vₒₙ has a value (fixed value) equal to or larger than an ON voltage of the transistor 15. The voltage V_{off} has a value (fixed value) lower than the ON voltage of the transistor 15.

Advantages

Next, an example of operation of the liquid crystal display device 1 of the embodiment is described. In the embodiment, the drive circuit 30 is used to drive the liquid crystal element 14, thereby the content image 41 is displayed on the whole or part of the screen 40, and the functional image 42 is displayed on part of the screen 40, for example, as illustrated in FIG. 3A. Furthermore, the content image signal 30A and the functional image signal 35A are synthesized so that the functional image 42 is temporally expanded or reduced with the predetermined, fixed position 43 (black point in the figure) as a reference, for example, as illustrated in FIG. 3B. Thus, even if the functional image 42 has large display area at the same signal level, it may be prevented that a particular pixel 13 is continuously applied with an image signal at a constant level. As a result, when the functional image 42 is a still image, burn-in caused by the still image may be reduced.

In particular, in the case that the functional image 42 is expanded or reduced in such a manner that when the total area of the screen 40 is assumed to be 1, area of the functional image 42 is 0.01 or more at the maximum, and 0 at the minimum, it may be securely prevented that a particular pixel 13 is continuously applied with an image signal at a constant level. As a result, when the functional image 42 is a still image, burn-in caused by the still image may be more reduced.

Furthermore, in the case that the functional image 42 is expanded or reduced in such a manner that the functional image 42 is temporally repeatedly faded out and faded in, for example, as illustrated in FIG. 6C, burn-in caused by the still image may be remarkably reduced. Similarly, in the case that the functional image 42 is expanded or reduced in such a manner that the functional image 42 is temporally repeatedly faded out or faded in, for example, as illustrated in FIG. 6A or 6B, burn-in caused by the still image may be still more reduced. Moreover, in the case that the functional image 42 is expanded or reduced in such a manner that a luminance level of the functional image 42 is increased and decreased within a luminance level range (I₁ or more) in which the functional image 42 is invisible, for example, as illustrated in FIG. 6D, burn-in caused by the still image may be sufficiently reduced.

Moreover, in the case that the functional image 42 is expanded or reduced such that the functional image 42 is displayed, for example, in a manner that at least part of an image portion of the content image 41 in the back of the functional image 42 is transparent, burn-in caused by the still image may be still more reduced. Furthermore, in the case that a blending ratio of the image portion in the back of the functional image 42 and the functional image 42 is temporally changed, burn-in caused by the still image may be more effectively reduced.

The present application contains subject matter related to that disclosed in Japanese Priority Patent Application JP 2009-111421 filed in the Japan Patent Office on Apr. 30, 2009 and Japanese Priority Patent Application JP 2009-157814 filed in the Japan Patent Office on Jul. 2, 2009, the entire content of which is hereby incorporated by references.

It should be understood by those skilled in the art that various modifications, combinations, sub-combinations and alterations may occur depending on design requirements and other factors insofar as they are within the scope of the appended claims or the equivalent thereof.

What is claimed is:

1. An image display method,
wherein a non-self-luminous display device is driven, so that a content image is displayed on a screen, and a functional image is displayed on part of the screen, and besides, the functional image is temporally expanded or reduced with a predetermined, fixed position as a reference.

2. The image display method according to claim 1,
wherein the functional image is expanded or reduced in such a manner that when the total area of a screen is assumed to be 1, area of the functional image is 0.01 or more at the maximum, and 0 at the minimum.

3. The image display method according to claim 1,
wherein the functional image is expanded or reduced while the fixed position is set within or outside a special region in which the functional image to be displayed, or within or outside a display region in which the functional image is currently displayed.

4. The image display method according to claim 1,
wherein a luminance level of the functional image is temporally changed from a luminance level at which the functional image is visible to a luminance level at which the functional image is invisible.

5. The image display method according to claim 1,
wherein a luminance level of the functional image is temporally changed from a luminance level at which the functional image is invisible to a luminance level at which the functional image is visible.

6. The image display method according to claim 1,
wherein a luminance level of the functional image is temporally changed in a manner of alternately repeating temporal change from a luminance level, at which the functional image is visible, to a luminance level at which the functional image is invisible, and temporal change from the luminance level, at which the functional image is invisible, to the luminance level at which the functional image is visible.

7. The image display method according to claim 1,
wherein a luminance level of the functional image is temporally changed in a manner of alternately repeating temporal change from a high luminance level to a low luminance level and temporal change from a low luminance level to a high luminance level within a luminance level range in which the functional image is visible.

8. The image display method according to claim 1,
wherein the functional image is displayed in a manner that an image portion of the content image in the back of the functional image is perfectly blocked, or at least part of the image portion in the back of the functional image is transparent.

9. An image display device, comprising:
a non-self-luminous display device having a screen;
an illumination section illuminating the display device; and
a drive section driving the display device so that a content image is displayed on the screen, and a functional image is displayed on part of the screen, and besides, the functional image is temporally expanded or reduced with a predetermined, fixed position as a reference.
